(19) United States
(12) Patent Application Publication
(10) Pub. No.: US 2024/0319957 A1
(43) Pub. Date: Sep. 26, 2024

(54) CONFERENCE-ORIENTED SOUND SYSTEM

(71) Applicant: Lenovo (Singapore) Pte. Ltd., Singapore (SG)

(72) Inventors: Upendra Baveja, Kanagawa (JP); Shigefumi Odaohhara, Kanagawa (JP); Takumi Imai, Kanagawa (JP); Joey Fausto Tolentino, Kanagawa (JP)

(73) Assignee: Lenovo (Singapore) Pte. Ltd., Singapore (SG)

(21) Appl. No.: 18/426,629

(22) Filed: Jan. 30, 2024

(30) Foreign Application Priority Data
Mar. 23, 2023 (JP) 2023-046168

(51) Int. Cl. G06F 3/16

(52) U.S. Cl. CPC G06F 3/165

(57) ABSTRACT

A conference-oriented sound system includes: a loudspeaker unit; and a microphone. The loudspeaker unit includes: a storage section that a conference-oriented frequency characteristic and a music-oriented frequency characteristic are stored; a setting section which sets the conference-oriented frequency characteristic as a characteristic which is to be used while a conference is being held and sets the music-oriented frequency characteristic as a characteristic which is to be used while music is being reproduced; and a signal adjustment section which adjusts sound data which is input by using the characteristic which is to be used. In a case where the setting section receives a signal which is used for notification of start of the conference, the setting section sets the conference-oriented frequency characteristic as the characteristic which is to be used.

### CROSS-REFERENCE TO RELATED APPLICATIONS

This application claims priority to Japanese Patent Application No. 2023-046168 filed on Mar. 23, 2023, the contents of which are hereby incorporated herein by reference in their entirety.

### TECHNICAL FIELD

The present disclosure relates to a conference-oriented sound system.

### BACKGROUND

Recently, the number of opportunities of performing teleworking is increased, Web conferences are frequently held in association therewith and various techniques which relate to the Web conferences are proposed (see, for example, Japanese Unexamined Patent Application Publication No. 2020-137095.

As sound systems (hereinafter, referred to as “conference-oriented sound systems”) which are used in the Web conferences, for example, a sound system which is a so-called speakerphone that a loudspeaker unit is integrated with a microphone, a sound system which is configured by connecting together the loudspeaker unit and the microphone in a wireless state or a wired state and so forth are known.

In the conference-oriented sound systems of the above-mentioned types, a frequency characteristic which suppresses output is used in order to avoid feedback of a signal which is generated by the loudspeaker unit to the conference opponent side through the microphone.

In recent years, a demand for using the conference-oriented sound system of the type such as that which is described above also for music reproduction grows. However, in a case where a conventional conference-oriented sound system is used for music reproduction, it is difficult to reproduce realistic sounds and improvement of user experience has been called for.

### SUMMARY

One or more embodiments of the present disclosure provide a conference-oriented sound system which makes it possible to promote improvement of the user experience in the music reproduction.

According to one or more embodiments of the present disclosure, there is provided a conference-oriented sound system which is equipped with a loudspeaker unit and a microphone, in which the loudspeaker unit includes a storage section that a conference-oriented frequency characteristic and a music-oriented frequency characteristic are stored, a setting section which sets the conference-oriented frequency characteristic as a characteristic which is to be used while a conference is being held and sets the music-oriented frequency characteristic as a characteristic which is to be used while music is being reproduced and a signal adjustment section which adjusts sound data which is input by using the characteristic which is to be used, and in a case where the setting section receives a signal which is used for notification of start of the conference, the setting section sets the conference-oriented frequency characteristic as the characteristic which is to be used.

According to one or more embodiments of the present disclosure, there is provided a conference-oriented sound system which is equipped with a loudspeaker unit and a microphone, in which the loudspeaker unit includes a storage section that a conference-oriented frequency characteristic and a music-oriented frequency characteristic are stored, a setting section which sets the conference-oriented frequency characteristic as a characteristic which is to be used while a conference is being held and sets the music-oriented frequency characteristic as a characteristic which is to be used while music is being reproduced and a signal adjustment section which adjusts sound data which is input by using the characteristic which is to be used.

According to one or more embodiments of the conference-oriented sound system of the present disclosure, such an effect that it becomes possible to promote improvement of the user experience in the music reproduction is exhibited.

### BRIEF DESCRIPTION OF THE DRAWINGS

FIG. 1 is a system configuration diagram schematically illustrating one example of an entire configuration of a conference-oriented sound system according to one or more embodiments of the present disclosure.

FIG. 2 is a functional configuration diagram illustrating one example of functions of a loudspeaker unit which pertains to one or more embodiments of the present disclosure.

FIG. 3 is a diagram illustrating one example of a graph which indicates a conference-oriented frequency characteristic and a music-oriented frequency characteristic which pertain to one or more embodiments of the present disclosure in comparison with each other.

FIG. 4 is a flowchart illustrating one example of processing procedures of a controlling method that the conference-oriented sound system executes according to one or more embodiments of the present disclosure.

### DETAILED DESCRIPTION

In the following, embodiments of a conference-oriented sound system 1 pertaining to the present disclosure will be described with reference to the drawings.

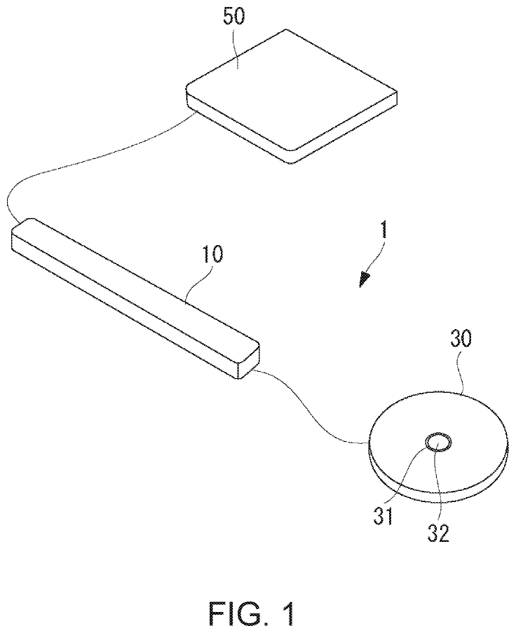

FIG. 1 is a system configuration diagram which schematically illustrates one example of the entire configuration of the conference-oriented sound system 1 according to one or more embodiments of the present disclosure. As illustrated in FIG. 1, the conference-oriented sound system 1 includes a loudspeaker unit 10 and a microphone 30.

The loudspeaker unit 10 and the microphone 30 are connected together via a wired line. It is possible to use a USB (Universal Serial Bus)-based communication system. In addition, the loudspeaker unit 10 and the microphone 30 may be wirelessly connected together via, for example, Bluetooth (registered trademark), Wi-Fi and so forth.

Incidentally, although in one or more embodiments, a case where the loudspeaker unit 10 and the microphone 30 are configured as separately installed units is illustrated, the configuration thereof is not limited thereto. The loudspeaker unit 10 and the microphone 30 may be integrated with each other and thereby may have a configuration that the loudspeaker unit 10 and the microphone 30 are mounted on one chassis.

The conference-oriented sound system 1 is connected with an information processing device 50 in a wireless or wired state and is configured to be communicable with the information processing device 50. As examples of the information processing device 50, for example, a laptop PC, a desktop PC, a tablet terminal, a smartphone and so forth are given. The configuration of the information processing device 50 is well-known and therefore detailed description thereof will be omitted here.

The microphone 30 includes an LED (Light-Emitting Diode: an illumination section) 31 and a mute switching section 32. The LED 31 is controlled by, for example, the loudspeaker unit 10. The LED 31 is put on in a mode which is different depending on each status. For example, in a case where the microphone 30 is in an ON-state (an unmute state), the LED 31 is putt on in green and in a case where the microphone 30 is in a mute state, the LED 31 is put on in red. In addition, in a case where the conference is concluded or the power source of the microphone 30 is in an OFF state, the LED 31 is put out.

The mute switching section 32 is an input section that a user operates for switching between the mute state and the unmute state. For example, the mute switching section 32 is installed in the form of an input button and the state is switched between the mute state and the unmute state every time that the mute switching section 32 is depressed by the user.

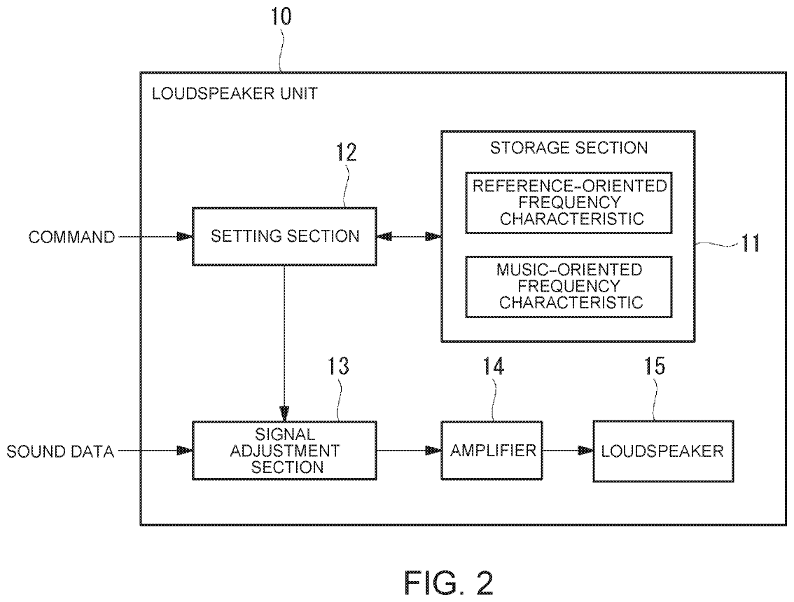

FIG. 2 is a function configuration diagram illustrating one example of functions that the loudspeaker unit 10 has. For example, the loudspeaker unit 10 has a computer which includes a CPU (Central Processing Unit: a processor), a main memory, a secondary storage (a secondary memory) and so forth. A series of processes for realizing various functions which will be described later is stored in the secondary storage and so forth in the form of a program by way of example and the CPU reads out this program to the main memory and executes information processing and arithmetic processing and, thereby, the various kinds of functions are realized.

As illustrated in FIG. 2, the loudspeaker unit 10 includes a storage section 11, a setting section 12, a signal adjustment section 13, an amplifier 14 and a loudspeaker 15. In addition, the loudspeaker unit 10 may further have functions that the loudspeaker generally has such as a volume adjustment function for adjusting the volume of the loudspeaker 15.

For example, a reference-oriented frequency characteristic which is suited for a conference such as, for example, the Web conference and a music-oriented frequency characteristic which is suited for music reproduction are stored in the storage section 11. The conference-oriented frequency characteristic is a frequency characteristic which is suited for the Web conference and is defined as a frequency characteristic which is suppressed in output, for example, in order to avoid feedback of a signal which is generated by the loudspeaker 15 to the conference opponent side via the microphone 30. In addition, the music-oriented frequency characteristic is defined as a frequency characteristic which is suited for music reproduction.

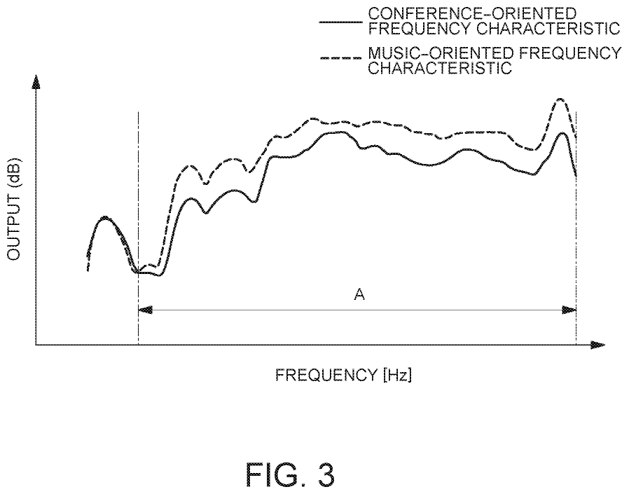

FIG. 3 is a diagram illustrating one example of a graph which shows the conference-oriented frequency characteristic and the music-oriented frequency characteristic in comparison with each other. In FIG. 3, the horizontal axis indicates the frequency (Hz) and the vertical axis indicates the output (dB). As illustrated in FIG. 3, in a predetermined frequency band A, the output of the music-oriented frequency characteristic is set to a value which is larger than the value of output from a reference-oriented equalizer.

The setting section 12 sets, for example, the conference-oriented frequency characteristic as a characteristic which is to be used while the conference is being held and sets, for example, the music-oriented frequency characteristic as a characteristic which is to be used while the music is being reproduced. For example, the setting section 12 sets the conference-oriented frequency characteristic as the characteristic which is to be used while the conference is being held and sets the music-oriented frequency characteristic as the characteristic which is to be used in a situation other than a case where the conference is being held.

For example, in a case where the setting section 12 receives a signal (hereinafter, referred to as a “conference start command”) which is used for notifying that the conference will be started from the information processing device 50, the setting section 12 sets the conference-oriented frequency characteristic as the characteristic which is to be used. The conference start command is, for example, a command for requesting to put on the LED 31 of the microphone 30 in green. This signal is output from the information processing device 50 to the loudspeaker unit 10 by using, for example, the HID protocol.

In addition, for example, in a case where the setting section 12 receives a signal (hereinafter, referred to as a “conference conclusion command”) which is used for notification of the conclusion of the conference from the information processing device 50, the setting section 12 sets the music-oriented frequency characteristic as the characteristic which is to be used. The conference conclusion command is, for example, a command for requesting to put out the LED 31 of the microphone 30. This signal is output from the information processing device 50 to the loudspeaker unit 10 by using, for example, the HID protocol.

The signal adjustment section 13 adjusts sound data which is input by using the characteristic which is set by the setting section 12. That is, the signal adjustment section 13 has a function of an equalizer which adjusts the sound data by using the characteristic which is to be used.

The amplifier 14 outputs the sound data which is adjusted by the signal adjustment section 13 to the loudspeaker 15. Thereby, the sound is output from the loudspeaker 15.

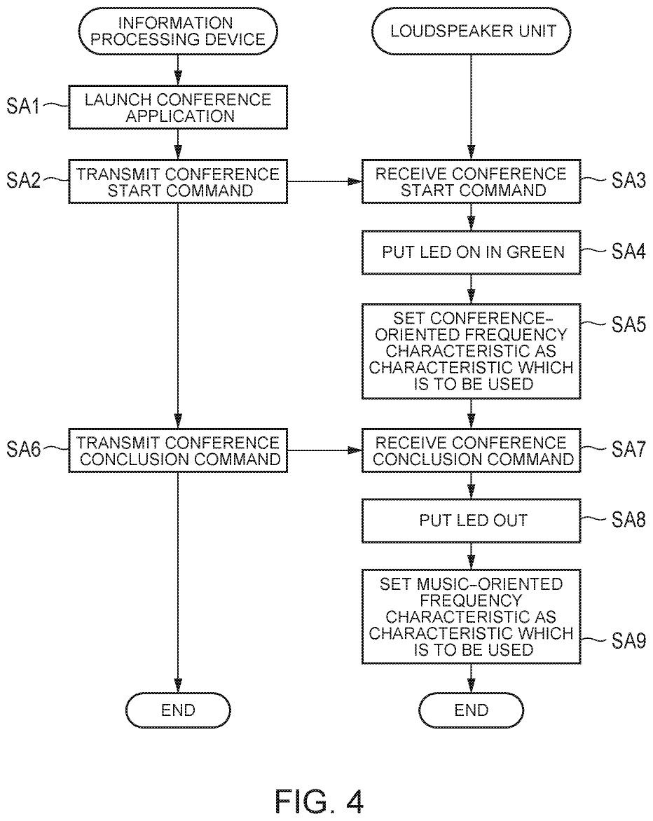

Next, the operation of the conference-oriented sound system 1 according to one or more embodiments of the present disclosure will be described with reference to FIG. 4. FIG. 4 is a flowchart illustrating one example of processing procedures of a controlling method that the conference-oriented sound system 1 according to one or more embodiments of the present disclosure executes. In the following, description will be made by exemplifying a case where the music-oriented frequency characteristic is set as the characteristic which is to be used as default setting.

First, in a case where an application (in the following, referred to as a “conference-oriented application”) of the Web conference is launched in the information processing device 50 in a state that the information processing device 50 is connected with the conference-oriented sound system 1 (SA1), a conference start command is transmitted from the information processing device 50 to the loudspeaker unit 10 of the conference-oriented sound system 1 (SA2).

The loudspeaker unit 10 receives the conference start command (SA3) and then puts the LED 31 of the microphone 30 on in green (SA4). In addition, the loudspeaker unit 10 sets the conference-oriented frequency characteristic as the characteristic which is to be used (SA5).

Thereby, while the Web conference is being held, the sound data which is received from the information processing device 50 is adjusted (subjected to signal processing) on the basis of the reference-oriented frequency characteristic by the signal adjustment section 13, is amplified by the amplifier 14 and is output from the loudspeaker 15 as sounds.

Then, in a case where the Web conference is concluded, a conference conclusion command is transmitted from the conference-oriented application of the information processing device 50 to the loudspeaker unit 10 (SA6). The loudspeaker unit 10 receives the conference conclusion command (SA7) and then puts the LED 31 of the microphone 30 out in accordance with this command (SA8). In addition, the loudspeaker unit 10 sets the music-oriented frequency characteristic as the characteristic which is to be used (SA9).

Thereby, in the loudspeaker unit 10, adjustment of the sound data which uses the music-oriented frequency characteristic is performed until the loudspeaker unit 10 receives the conference start command next time. Thereby, for example, in a case where a music reproduction command is received and sound data on the music is input, adjustment of the sound data which uses the music-oriented frequency characteristic is performed by the signal adjustment section 13 and sound data which is obtained after adjustment is amplified by the amplifier 14 and is output from the loudspeaker 15 as sounds.

As described above so far, according to one or more embodiments of the present disclosure, the reference-oriented sound system 1 includes the loudspeaker unit 10 and the microphone 30. In addition, the loudspeaker unit 10 includes the storage section 11 that the reference-oriented frequency characteristic and the music-oriented frequency characteristic are stored, the setting section 12 which sets the conference-oriented frequency characteristic as the characteristic which is to be used while the conference is being held and sets the music-oriented frequency characteristic as the characteristic which is to be used while the music is being reproduced and the signal adjustment section 13 which adjusts the sound data which is input by using the characteristic which is to be used.

Thereby, it becomes possible to switch to an appropriate frequency characteristic depending on the intended use of the conference-oriented sound system 1. That is, it becomes possible to perform adjustment of the sound data which uses the conference-oriented frequency characteristic while the conference is being held and to perform adjustment of the sound data which uses the music-oriented frequency characteristic at the time of music reproduction. Thereby, it becomes possible to output realistic feeling sounds at the time of music reproduction and thereby it becomes possible to improve the user experience.

In addition, according to one or more embodiments of the present disclosure, in a case where the setting section 12 receives the signal which is used for notification of start of the conference, specifically, the command for requesting to put the LED 31 on, the setting section 12 sets the conference-oriented frequency characteristic as the characteristic which is to be used. In addition, in a case where the setting section 12 receives the signal which is used for notification of conclusion of the conference, specifically, the command for requesting to put the LED 31 out, the setting section 12 sets the music-oriented frequency characteristic as the characteristic which is to be used. Since the commands for requesting to put the LED 31 on and to put the LED 31 out are used also for switching between the frequency characteristics in this way, it becomes possible to readily switch between the frequency characteristics without changing elaboration of the application.

Although the present disclosure has been described above by using the above embodiments, the technical scope of the present disclosure is not limited to the scope which is described in the above embodiments. It is possible to add various modifications and improvements to the above embodiments within a range not deviating from the gist of the present disclosure and also a form which is modified or improved falls within the technical scope of the present disclosure.

In addition, also the flow of processing which is described in the above embodiments is merely one example and an unnecessary step may be deleted, a new step may be added and the order of the steps to be processed may be changed within the range not deviating from the gist of the present disclosure.

For example, although in one or more embodiments, the music-oriented frequency characteristic is set as the default of the frequency characteristic, the characteristic which is set as the default is not limited thereto. For example, in a case where the conference-oriented frequency characteristic is set as the default of the frequency characteristic and a command for requesting to start music reproduction is received from a device which is installed on a music data provision destination such as the information processing device 50 or the like, the music-oriented frequency characteristic may be set as the default and in a case where a command for requesting to terminate the music reproduction, the conference-oriented frequency characteristic may be set as the default.

### DESCRIPTION OF SYMBOLS

1: conference-oriented sound system
10: loudspeaker unit
11: storage section
12: setting section
13: signal adjustment section
14: amplifier
15: loudspeaker
30: microphone
31: LED
32: mute switching section
50: information processing device

What is claimed is:

1. A conference-oriented sound system comprising:
a loudspeaker unit; and
a microphone, wherein
the loudspeaker unit includes
a storage section that a conference-oriented frequency characteristic and a music-oriented frequency characteristic are stored,
a setting section which sets the conference-oriented frequency characteristic as a characteristic which is to be used while a conference is being held and sets the music-oriented frequency characteristic as a characteristic which is to be used while music is being reproduced and
a signal adjustment section which adjusts sound data which is input by using the characteristic which is to be used, and
in a case where the setting section receives a signal which is used for notification of start of the conference, the setting section sets the conference-oriented frequency characteristic as the characteristic which is to be used.

2. The conference-oriented sound system according to claim 1, wherein
the microphone includes an illumination section which is put on in a mode which is different depending on each status and
a signal which is used for notification of start of the conference includes a command for requesting to put the illumination section of the microphone on.

3. The conference-oriented sound system according to claim 1, wherein
in a case where the setting section receives a signal which is used for notification of conclusion of the conference, the setting section sets the music-oriented frequency characteristic as the characteristic which is to be used.

4. The conference-oriented sound system according to claim 3, wherein
the microphone includes an illumination section which is put out in a mode which is different depending on each status and
a signal which is used for notification of the conclusion of the conference includes a command for requesting to put the illumination section of the microphone out.

5. The conference-oriented sound system according to claim 1, wherein
in a predetermined frequency band, output of the music-oriented frequency characteristic is set to a value which is larger than a value of output of the conference-oriented frequency characteristic.

6. A conference-oriented sound system comprising:
a loudspeaker unit; and
a microphone, wherein
the loudspeaker unit includes
a storage section that a conference-oriented frequency characteristic and a music-oriented frequency characteristic are stored,
a setting section which sets the conference-oriented frequency characteristic as a characteristic which is to be used while a conference is being held and sets the music-oriented frequency characteristic as a characteristic which is to be used while music is being reproduced and
a signal adjustment section which adjusts sound data which is input by using the characteristic which is to be used.
